(19) United States
(12) Patent Application Publication
(10) Pub. No.: US 2025/0042699 A1
(43) Pub. Date: Feb. 6, 2025

(54) ESCALATOR ENTRAPMENT DETECTION SYSTEM

(71) Applicant: Otis Elevator Company, Farmington, CT (US)

(72) Inventors: Randall Roberts, Hebron, CT (US); Johanna Whitwell, Hartford, CT (US)

(21) Appl. No.: 18/364,297

(22) Filed: Aug. 2, 2023

(51) Int. Cl. B66B 29/08; B66B 25/00; B66B 27/00

(52) U.S. Cl. CPC B66B 29/08; B66B 25/003; B66B 27/00

(57) ABSTRACT

An escalator system is provided and includes a combplate, a moving step, which is drivable to move in a conveyance direction along the combplate, to pass by the combplate at a step-combplate interface and an entrapment monitoring and detection system. The entrapment monitoring and detection system includes a sensor disposed at the step-combplate interface and configured to sense an object being present at the step-combplate interface and a processor configured to determine whether the sensor senses the object being present at the step-combplate interface for a predetermined time.

### BACKGROUND

The present disclosure relates to escalator systems and, in particular, to a system and method that provide for LiDAR-based traffic monitoring and entrapment detection.

Conveyors of people, such as escalators and moving walkways, usually include a conveyance band that moves with people standing on it between opposing landing zones, driving machines that drive movement of the conveyance band and combplate. The conveyance band extends and moves between the opposing landing zones and has a surface that often includes cleats and grooves. The combplates are provided at the opposing landing zones. Each combplate includes teeth that extend into the grooves of the surface of the conveyance band as the conveyance band moves relative to each combplate and the cleats move along each of the teeth.

Entrapment of foreign objects, such as cloth threads, parts of a human body and bent cleats, at the combplates may cause operational problems and damage. Therefore, a need exists for a system and method that provide for traffic monitoring and entrapment detection for a combplate to allow for reliable detection of entrapment incidents.

### SUMMARY

According to an aspect of the disclosure, an escalator system is provided and includes a combplate, a moving step, which is drivable to move in a conveyance direction along the combplate, to pass by the combplate at a step-combplate interface and an entrapment monitoring and detection system. The entrapment monitoring and detection system includes a sensor disposed at the step-combplate interface and configured to sense an object being present at the step-combplate interface and a processor configured to determine whether the sensor senses the object being present at the step-combplate interface for a predetermined time.

In accordance with additional or alternative embodiments, the combplate includes teeth and the moving step includes alternating grooves and cleats and the moving step is drivable to move in the conveyance direction along the combplate such that the teeth pass through the grooves at the step-combplate interface.

In accordance with additional or alternative embodiments, the sensor is a LiDAR sensor.

In accordance with additional or alternative embodiments, the sensor is a RADAR sensor.

In accordance with additional or alternative embodiments, the sensor is a camera.

In accordance with additional or alternative embodiments, the sensor is one or more of a LiDAR sensor, a RADAR sensor or a camera.

In accordance with additional or alternative embodiments, the sensor is configured to execute periodic sensing and is further configured to generate signals during the periodic sensing which are receivable and readable by the processor.

In accordance with additional or alternative embodiments, when no object is present at the step-combplate interface, the signals are first signals and are reflective of a width of the moving step, when an object is present at the step-combplate interface for less than the predetermined time, the signals deviate from the first signals and persist for less than the predetermined time and, when an object is present at the step-combplate interface for at least the predetermined time, the signals deviate from the first signals and persist for at least the predetermined time.

In accordance with additional or alternative embodiments, the processor is further configured to judge that an entrapment incident is in effect in accordance with an affirmative determination that the sensor senses the object being present at the step-combplate interface for the predetermined time and to take a mitigation action accordingly and the mitigation action includes at least one or more of braking or slowing the escalator system, setting off an alarm and adjusting the combplate.

According to an aspect of the disclosure, an escalator system is provided and includes a combplate, moving steps and an entrapment monitoring and detection system. The combplate includes teeth. Each moving step includes alternating grooves and cleats and is drivable to move in a conveyance direction along the combplate to pass by the combplate such that the teeth pass through the grooves at a step-combplate interface. The entrapment monitoring and detection system includes a sensor disposed at the step-combplate interface and configured to sense an object being present at the step-combplate interface and a processor. The processor is configured to determine whether the sensor senses the object being present at the step-combplate interface for a predetermined time, to judge that an entrapment incident is in effect in accordance with an affirmative determination that the sensor senses the object being present at the step-combplate interface for the predetermined time and to take a mitigation action accordingly.

In accordance with additional or alternative embodiments, the sensor is a LiDAR sensor.

In accordance with additional or alternative embodiments, the sensor is a RADAR sensor.

In accordance with additional or alternative embodiments, the sensor is a camera.

In accordance with additional or alternative embodiments, the sensor is one or more of a LiDAR sensor, a RADAR sensor or a camera.

In accordance with additional or alternative embodiments, the sensor is configured to execute periodic sensing and is further configured to generate signals during the periodic sensing which are receivable and readable by the processor.

In accordance with additional or alternative embodiments, when no object is present at the step-combplate interface, the signals are first signals and are reflective of a width of the moving steps, when an object is present at the step-combplate interface for less than the predetermined time, the signals deviate from the first signals and persist for less than the predetermined time and, when an object is present at the step-combplate interface for at least the predetermined time, the signals deviate from the first signals and persist for at least the predetermined time.

In accordance with additional or alternative embodiments, the sensor is provided as sensors respectively disposed at multiple locations at or near the step-combplate interface and configured to sense an object being present at the multiple locations at or near the step-combplate interface and the processor is configured to determine whether the sensors sense the object being present at the multiple locations at or near the step-combplate interface.

According to an aspect of the disclosure, a method of operating an entrapment monitoring and detection system of an escalator system in which a moving step passes by a combplate at a step-combplate interface is provided. The method includes scanning the step-combplate interface, determining whether results of the scanning are indicative of an object at the step-combplate interface, determining whether the results of the scanning are indicative of the object at the step-combplate interface persisting for a predetermined time and judging that an entrapment is in effect in accordance with the results of the scanning being indicative of the object at the step-combplate interface and persisting for the predetermined time.

In accordance with additional or alternative embodiments, the method further includes determining escalator traffic by counting a total number of objects persisting at the step-combplate interface for less than the predetermined time and a number of objects persisting at the step-combplate interface for at least the predetermined time.

In accordance with additional or alternative embodiments, the method further includes taking a mitigation action to address the entrapment, the mitigation action comprising at least one or more of braking or slowing the escalator system, setting off an alarm and adjusting the combplate.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a perspective view of an escalator system in accordance with embodiments FIG. 1 is a perspective view of an elevator system in accordance with embodiments;

FIG. 2 is an enlarged perspective view of landing of the elevator system of FIG. 1 in accordance with embodiments;

FIG. 3 is a side view of components of an escalator system having an entrapment monitoring and detection system in accordance with embodiments;

FIG. 4A is an enlarged side view of a step-combplate interface of the escalator system of FIG. 3 and a sensor of the entrapment monitoring and detection system in accordance with embodiments;

FIG. 4B is a top-down view of the step-combplate interface of FIG. 4A in accordance with embodiments;

FIG. 5 is a graphical depiction of an operation of the escalator system having the entrapment monitoring and detection system of FIGS. 3 and 4; and

FIG. 6 is a flow diagram illustrating a method of operating an entrapment monitoring and detection system of an escalator system in accordance with embodiments.

### DETAILED DESCRIPTION

In escalator technology, passenger safety risks are associated with riding on escalators. These include over-crowding that can cause riders to stumble and entrapments of personal items (e.g., shoes, laces or clothing items) at the interface of moving steps and the combplate.

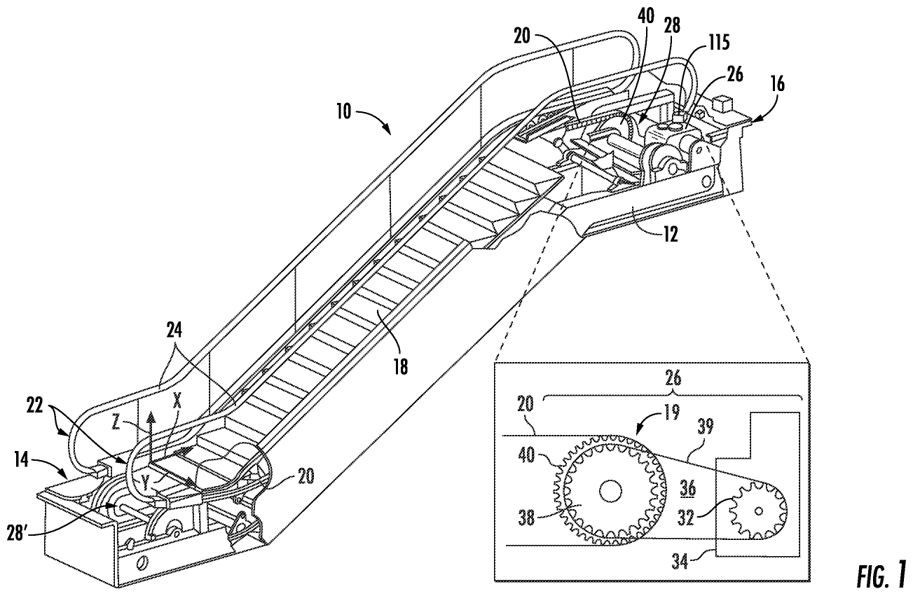

Thus, as will be described below, a method and system are provided to monitor and identify both types of risks. A light detection and ranging (LiDAR) sensor or another similar type of sensor is installed at the step-combplate interface. The sensor emits a light beam that effectively detects the nearest object in its path. When no passengers are present, the sensor returns a signal that is reflective of the width of the escalator (i.e., the distance to the opposite wall). When an object persists at the step-combplate interface for a certain period of time, the object obscures the sensor. The sensor then returns a signal that is reflective of the distance to the object and the system infers an entrapment incident. With reference to FIG. 1, an escalator 10 is provided. It should become apparent in the ensuing description that the invention is applicable to other passenger conveyor systems, such as moving walks. The escalator 10 generally includes a truss 12 extending between a lower landing 14 and an upper landing 16. A plurality of sequentially connected steps or tread plates 18 are connected to a step chain 20 and travel through a closed loop path within the truss 12. A pair of balustrades 22 are disposed on either side of the escalator 10, with each balustrade 22 including a moving handrail 24. A drive machine 26, or drive system, is typically located in a machine space 28 under the upper landing 16. An additional machine space 28′ can be located under the lower landing 14. The drive machine 26 is configured to drive the tread plates 18 and/or handrails 24 through the step chain 20. The drive machine 26 operates to move the tread plates 18 in a chosen direction at a desired speed under normal operating conditions.

The tread plates 18 make a 180 degree heading change in a turn-around area 19 located under the lower landing 14 and the upper landing 16. The tread plates 18 are pivotally attached to the step chain 20 and follow a closed loop path of the step chain 20, running from one landing to the other, and back again.

The drive machine 26 includes a first drive member 32, such as a motor output sheave, connected to a drive motor 34 through a belt reduction assembly 36 including a second drive member 38, such as an output sheave, driven by a tension member 39, such as an output belt. The first drive member 32 in some embodiments is a driving member, and the second drive member 38 is a driven member.

As used herein, the first drive member 32 and/or the second drive member 38, in various embodiments, may be any type of rotational device, such as a sheave, pulley, gear, wheel, sprocket, cog, pinion, etc. The tension member 39, in various embodiments, can be configured as a chain, belt, cable, ribbon, band, strip, or any other similar device that operatively connects two elements to provide a driving force from one element to another. For example, the tension member 39 may be any type of interconnecting member that extends between and operatively connects the first drive member 32 and a second drive member 38. In some embodiments, as shown in FIG. 1, the first drive member 32 and the second drive member may provide a belt reduction. For example, first drive member 32 may be approximately 75 mm (2.95 inches) in diameter while the second drive member 38 may be approximately 750 mm (29.53 inches) in diameter. The belt reduction, for example, allows the replacement of sheaves to change the speed for 50 or 60 Hz electrical supply power applications, or different step speeds. However, in other embodiments the second drive member 38 may be substantially similar to the first drive member 32.

As noted, the first drive member 32 is driven by drive motor 34 and thus is configured to drive the tension member 39 and the second drive member 38. In some embodiments the second drive member 38 may be an idle gear or similar device that is driven by the operative connection between the first drive member 32 and the second drive member 38 by means of tension member 39. The tension member 39 travels around a loop set by the first drive member 32 and the second drive member 38, which herein after may be referred to as a small loop. The small loop is provided for driving a larger loop which consists of the step chain 20, and is driven by an output sheave 40, for example. Under normal operating conditions, the tension member 39 and the step chain 20 move in unison, based upon the speed of movement of the first drive member 32 as driven by the drive motor 34.

The escalator 10 also includes a controller 115 that is in electronic communication with the drive motor 34. The controller 115 may be located, as shown, in the machine space 28 of the escalator 10 and is configured to control the operation of the escalator 10. For example, the controller 115 may provide drive signals to the drive motor 34 to control the acceleration, deceleration, stopping, etc. of the tread plates 18 through the step chain 20. The controller 115 may be an electronic controller including a processor and an associated memory comprising computer-executable instructions that, when executed by the processor, cause the processor to perform various operations. The processor may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

Although described herein as a particular escalator drive system and particular components, this is merely exemplary, and those of skill in the art will appreciate that other escalator system configurations may operate with the invention disclosed herein.

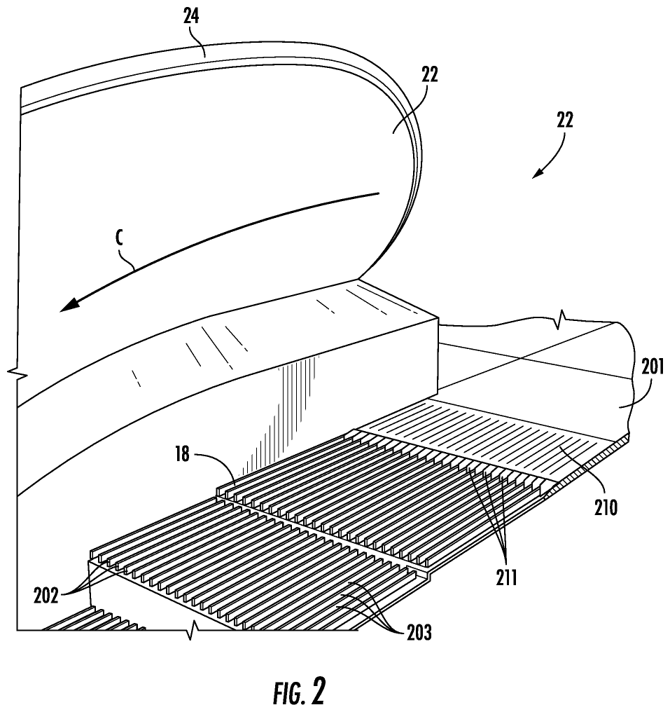

With reference to FIG. 2, the tread plates 18 of FIG. 1 can be provided as plurality of steps and the lower landing 14 and the upper landing 16 of FIG. 1 can include a floor plate 201. An upper surface of each of the steps (i.e., tread plates 18) can be provided with a plurality of alternating grooves 202 and cleats 203 extending in the conveyance direction C. A combplate 210 is arranged next to the floor plate 201 on the side of the floor plate 201 facing the steps. The combplate 210 includes a plurality of teeth 211 extending parallel to the conveyance direction C. The teeth 211 are arranged in a staggered relation with the cleats 203 of the steps and extend into the grooves 202.

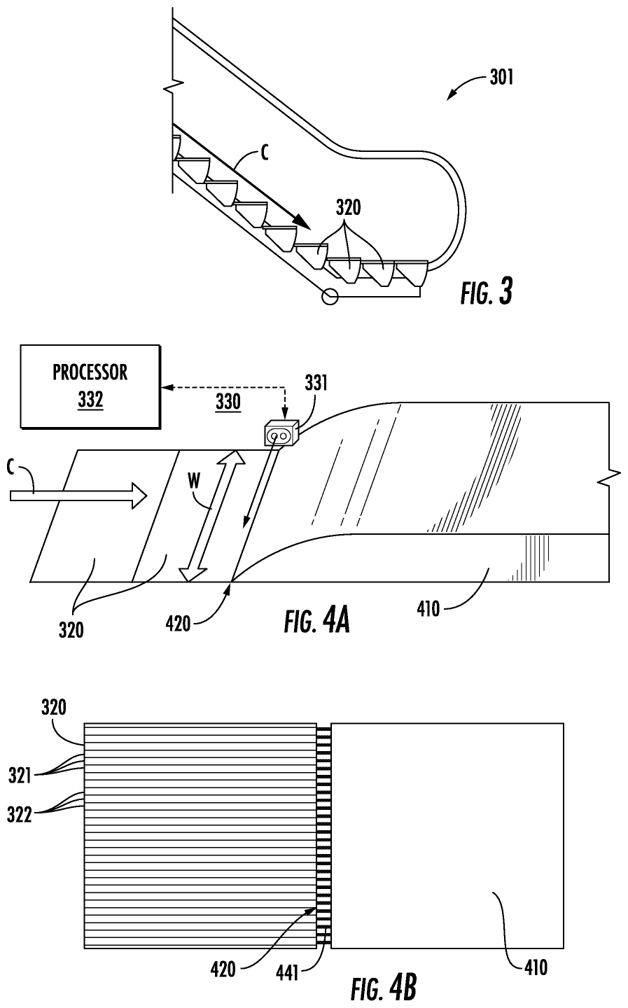

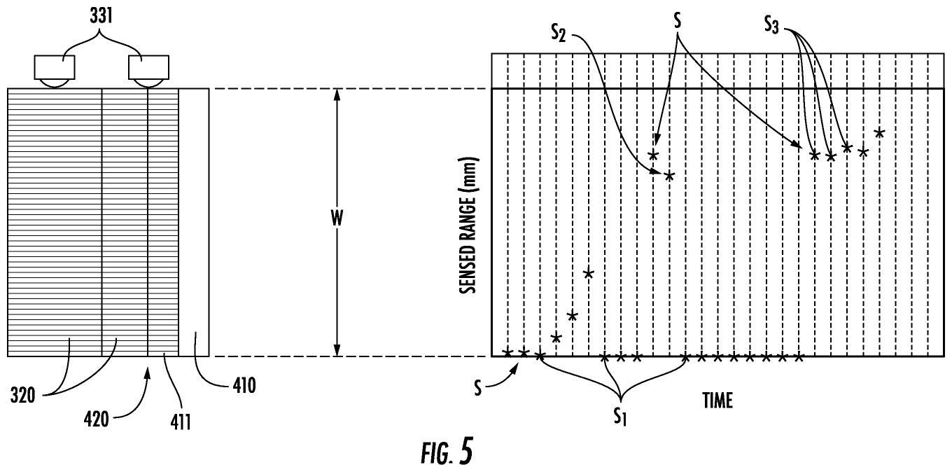

With reference to FIGS. 3-5, an escalator system 301 is provided. The escalator system 301 includes a combplate 410 (see FIG. 4), moving steps 320 and an entrapment monitoring and detection system 330.

The combplate 410 includes teeth 411 that are arrayed along an edge 412 of the combplate 410 in a width-wise dimension W of the moving steps 320. Each of the moving steps 320 includes alternating grooves 321 and cleats 322. Each of the moving steps 320 is drivable to move in a conveyance direction C, which is perpendicular to the width-wise dimension W, to pass by the combplate 410 at a step-combplate interface 420. With the movement of the moving steps 320 in the conveyance direction C, the teeth 411 pass through the corresponding grooves 321 of each moving step 320 at the step-combplate interface 420. The entrapment monitoring and detection system 330 includes a sensor 331 and a processor 332. The sensor 331 is disposed at or near to the step-combplate interface 420 and is configured to sense an object being present at the step-combplate interface 420 at any point along the width-wise dimension W.

The processor 332 is operably coupled to the sensor 331 and includes a processing unit, a networking unit by which the processing unit is communicative with the sensor 331 and external devices and a memory. The memory has executable instructions stored thereon, which, when executed, cause the processing unit to operate as described herein. The following description will refer to the processor 332 generally.

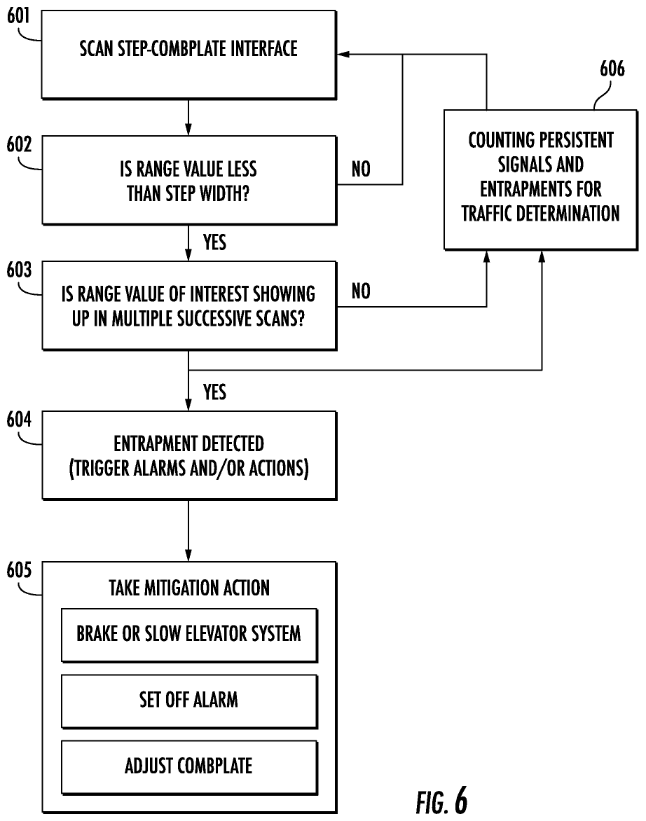

The processor 332 is configured to determine whether the sensor 331 senses the object being present at the step-combplate interface 420 for a predetermined time. In addition, the processor 332 is further configured to judge that an entrapment incident is in effect in accordance with an affirmative determination that the sensor 331 senses the object being present at the step-combplate interface 420 for the predetermined time and to take a mitigation action accordingly. In accordance with one or more alternative embodiments, the mitigation action can include at least one or more of braking or slowing the escalator system 301, setting off an alarm and adjusting the combplate 410 (see FIG. 6).

In accordance with embodiments, the sensor 331 can include or be provided as one or more of a light detection and ranging or a laser imaging, detection, and ranging (LiDAR) sensor, a radio detection and ranging (RADAR) sensor and/or a camera. In accordance with further embodiments, the sensor 310 can be provided as one or more of a 2D LiDAR sensor, a millimeter wave RADAR sensor and/or a red, green, blue, depth (RGBD) camera. In accordance with still further embodiments, the sensor 310 can be provided as plural sensors including a combination of one or more sensor types listed herein.

In accordance with further embodiments as shown in FIG. 5, the sensor 331 can be provided as multiple sensors 331 that sense or scan at similar or different wavelengths at locations at or near the step-combplate interface 420. In these or other cases, the multiple sensors 331 can be arranged on a same side of the step-combplate interface 420 and/or at opposite sides of the step-combplate interface 420. In the former instance, the multiple sensors 331 arranged on the same side of the step-combplate interface 420 could be configured to sense or scan in substantially same or similar directions. Conversely, in the latter case, the multiple sensors 331 arranged on opposite sides of the step-combplate interface 420 could be arranged in a coaxial or staggered formation and could configured to sense or scan in substantially opposed directions.

The multiple sensors 331 can be employed for redundancy, confirmation of sensing results and traffic monitoring and detection in cases where objects on an escalator that may not be sensed by one sensor 331 are likely to be sensed by another sensor 331. The multiple sensors 331 could also be used to infer relative movement of objects or in an assessment of a movement of an object that occurs between sets of the multiple sensors 331. That is, if a foot is planted on the moving step 320, then there would be a time delay between the upstream one of the multiple sensors 331 and the downstream one of the multiple sensors 331.

As is also shown in FIG. 5, which is illustrative of data that can be generated by the sensor 331, particularly where the sensor 331 is a LiDAR sensor, the sensor 331 can be configured to execute periodic sensing and can be further configured to generate the data as signals S during the periodic sensing. These signals S can be receivable and readable by the processor 332. When no object is present at the step-combplate interface 420, the signals S are first signals S₁ and are reflective of a width W of each of the moving steps 320, which is unchangeable. When an object is present at the step-combplate interface 420 for less than the predetermined time, which could be anywhere in the range of milliseconds to seconds or longer, the signals S deviate from the first signals S₁ and persist as second signals S₂ for less than the predetermined time. When an object is present at the step-combplate interface 420 for at least the predetermined time, the signals S deviate from the first signals S₁ and persist as third signals S₃ for at least the predetermined time. As used herein, the deviation of the second signals S₂ and the third signals S₃ from the first signals S₁ manifests as data points that are not reflective of the width W of the moving steps 320 but rather the shorter and variable distance between the sensor 331 and the object that is present at the step-combplate interface 420.

The processor 332 can be trained or otherwise programmed to recognize the width W and the respective distances reflected by the first signals S₁, the second signals S₂ and the third signals S₃ using various types of training scenarios and modeling. In particular, the processor 332 can be trained or programmed to distinguish the third signals S₃ from the first signals S₁ and from the second signals S₂ to judge, from the third signals S₃, that the entrapment incident is in effect and to subsequently take the mitigation action.

It is to be understood that the training of the processor 332 includes training the processor 332 to recognize that certain groups of signals are to be read together in ascertaining persistence whereas other groupings of signals may not qualify to be read together. This can be achieved by defining a maximum distance between discrete signals and recognizing that discrete signals that are separated from one another by a distance that exceeds this maximum distance are not to be read together.

In accordance with additional embodiments, the escalator system 301 can also be configured for traffic monitoring to sense over-crowding of an escalator. In these or other cases, the persistence of detected objects could provide an indication of traffic even where the persistence is less than the predetermined time. Objects, such as normal steps for example, might persist for 0-250 milliseconds, while objects persisting for greater than 250 milliseconds could be deemed to indicate entrapment. Thus, the sensor 331 and the processor 332 can cooperatively monitor traffic by counting the number of objects that persist for a time that is less than the predetermined time without triggering a mitigation action.

With reference to FIG. 6, a method of operating an entrapment monitoring and detection system of an escalator system as described above is provided. The method includes scanning a step-combplate interface (block 601), determining whether results of the scanning are indicative of an object at the step-combplate interface (block 602), determining whether the results of the scanning are indicative of the object at the step-combplate interface persisting for a predetermined time (block 603) and judging that an entrapment is in effect in accordance with the results of the scanning being indicative of the object at the step-combplate interface and persisting for the predetermined time (block 603). In addition, the method can also include taking a mitigation action to address the entrapment (block 604), such as by at least one or more of braking or slowing the escalator system, setting off an alarm and adjusting the combplate. In accordance with additional embodiments, the method can further include counting persistent signals (i.e., those signals that represent objects persisting at the step-combplate interface for less than the predetermined time) and entrapments (i.e., those signals that represent objects persisting at the step-combplate interface for at least the predetermined time) for purposes of traffic determination (block 606).

Technical effects and benefits of the present disclosure are the provision of a fast-responding, retrofittable detection system that can monitor and detect escalator over-crowding and entrapments at the step-combplate interface at the escalator entrance or exit. The output of the system can be used to count traffic on an escalator and/or to trigger safety-related actions, such as deployment of the traditional escalator safety brakes or other new safety devices, such as a combplate release device.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. An escalator system, comprising:
a combplate;
a moving step, which is drivable to move in a conveyance direction along the combplate, to pass by the combplate at a step-combplate interface; and
an entrapment monitoring and detection system comprising:
a sensor disposed at the step-combplate interface and configured to sense an object being present at the step-combplate interface; and
a processor configured to determine whether the sensor senses the object being present at the step-combplate interface for a predetermined time.

2. The escalator system according to claim 1, wherein:
the combplate comprises teeth and the moving step comprises alternating grooves and cleats, and
the moving step is drivable to move in the conveyance direction along the combplate such that the teeth pass through the grooves at the step-combplate interface.

3. The escalator system according to claim 1, wherein the sensor is a LiDAR sensor.

4. The escalator system according to claim 1, wherein the sensor is a RADAR sensor.

5. The escalator system according to claim 1, wherein the sensor is a camera.

6. The escalator system according to claim 1, wherein the sensor is one or more of a LiDAR sensor, a RADAR sensor or a camera.

7. The escalator system according to claim 1, wherein the sensor is configured to execute periodic sensing and is further configured to generate signals during the periodic sensing which are receivable and readable by the processor.

8. The escalator system according to claim 7, wherein:
when no object is present at the step-combplate interface, the signals are first signals and are reflective of a width of the moving step,
when an object is present at the step-combplate interface for less than the predetermined time, the signals deviate from the first signals and persist for less than the predetermined time, and
when an object is present at the step-combplate interface for at least the predetermined time, the signals deviate from the first signals and persist for at least the predetermined time.

9. The escalator system according to claim 1, wherein:
the processor is further configured to judge that an entrapment incident is in effect in accordance with an affirmative determination that the sensor senses the object being present at the step-combplate interface for the predetermined time and to take a mitigation action accordingly, and
the mitigation action comprises at least one or more of braking or slowing the escalator system, setting off an alarm and adjusting the combplate.

10. An escalator system, comprising:
a combplate comprising teeth;
moving steps, each comprising alternating grooves and cleats and being drivable to move in a conveyance direction along the combplate to pass by the combplate such that the teeth pass through the grooves at a step-combplate interface; and
an entrapment monitoring and detection system comprising:
a sensor disposed at the step-combplate interface and configured to sense an object being present at the step-combplate interface; and
a processor configured to determine whether the sensor senses the object being present at the step-combplate interface for a predetermined time, to judge that an entrapment incident is in effect in accordance with an affirmative determination that the sensor senses the object being present at the step-combplate interface for the predetermined time and to take a mitigation action accordingly.

11. The escalator system according to claim 10, wherein the sensor is a LiDAR sensor.

12. The escalator system according to claim 10, wherein the sensor is a RADAR sensor.

13. The escalator system according to claim 10, wherein the sensor is a camera.

14. The escalator system according to claim 10, wherein the sensor is one or more of a LiDAR sensor, a RADAR sensor or a camera.

15. The escalator system according to claim 10, wherein the sensor is configured to execute periodic sensing and is further configured to generate signals during the periodic sensing which are receivable and readable by the processor.

16. The escalator system according to claim 15, wherein:
when no object is present at the step-combplate interface, the signals are first signals and are reflective of a width of the moving steps,
when an object is present at the step-combplate interface for less than the predetermined time, the signals deviate from the first signals and persist for less than the predetermined time, and
when an object is present at the step-combplate interface for at least the predetermined time, the signals deviate from the first signals and persist for at least the predetermined time.

17. The escalator system according to claim 10, wherein:
the sensor is provided as sensors respectively disposed at multiple locations at or near the step-combplate interface and configured to sense an object being present at the multiple locations at or near the step-combplate interface, and
the processor is configured to determine whether the sensors sense the object being present at the multiple locations at or near the step-combplate interface.

18. A method of operating an entrapment monitoring and detection system of an escalator system in which a moving step passes by a combplate at a step-combplate interface, the method comprising:
scanning the step-combplate interface;
determining whether results of the scanning are indicative of an object at the step-combplate interface;
determining whether the results of the scanning are indicative of the object at the step-combplate interface persisting for a predetermined time; and
judging that an entrapment is in effect in accordance with the results of the scanning being indicative of the object at the step-combplate interface and persisting for the predetermined time.

19. The method according to claim 18, further comprising determining escalator traffic by counting a total number of objects persisting at the step-combplate interface for less than the predetermined time and a number of objects persisting at the step-combplate interface for at least the predetermined time.

20. The method according to claim 18, further comprising taking a mitigation action to address the entrapment, the mitigation action comprising at least one or more of braking or slowing the escalator system, setting off an alarm and adjusting the combplate.
